(19) United States
(12) Patent Application Publication
(10) Pub. No.: US 2007/0294477 A1
(43) Pub. Date: Dec. 20, 2007

(54) Raid management apparatus, raid management method, and computer product

(75) Inventors: Toshihide Yanagawa, Kawasaki (JP); Hiroshi Yazawa, Kawasaki (JP); Yoshio Ookubo, Kanazawa (JP); Masato Yamagami, Kawasaki (JP); Masaru Shibata, Kawasaki (JP); Himiko Kaneko, Kawasaki (JP)

Correspondence Address: Patrick G. Burns - Reg. No. 29,367;GREER, BURNS & CRAIN, LTD., Suite 2500, 300 South Wacker Drive, Chicago, IL, 60606, US

(73) Assignee: Fujitsu Limited, Kawasaki-shi (JP)

(21) Appl. No.: 11/805,834

(22) Filed: May 24, 2007

Related U.S. Application Data
(63) Continuation of application No. PCT/JP04/17483, filed on Nov. 25, 2004.

(51) Int. Cl. G06F 12/00

(52) U.S. Cl. 711/114; 711/E12.081

(57) ABSTRACT

In a RAID management apparatus, a disk determination unit accesses each of RAID devices, determines a copy source disk, and sets a pointer of the determined copy source disk into a disk management table stored in a storage unit. When an input-output (I/O) processing unit accesses a disk, if an I/O error occurs on the disk, as a result a copy source disk and a copy destination disk are switched; the I/O processing unit renews a pointer associated with the copy source disk in the disk management table stored in the storage unit, and a disk notification unit notifies that the copy source disk and the copy destination disk are switched.

### BACKGROUND OF THE INVENTION

1. Field of the Invention

The present invention generally relates to a technology for management of a RAID management apparatus that performs mirroring among a plurality of disks.

2. Description of the Related Art

To avoid data loss caused by a trouble on a disk (such as a disk crash), one of currently known technologies is a device of redundant array of independent disks (RAID) that improves data security by performing mirroring among a plurality of disks.

Conventionally, when writing data onto disks that form the RAID device or when executing mirroring between disks, for example, a volume manager is used to manage the RAID device so that the volume manager writes data onto a plurality of disks, and to maintain synchronization between mirrored disks.

However, along with the recent enhancement of functions provided by RAID devices, a RAID device itself has become to execute mirroring and to maintain synchronization between disks.

Japanese Patent Application Laid-open No. 2002-123406 discloses a technology that can appropriately cope with a trouble when the trouble occurs in an active system node, by switching a standby system node into an active mode, halting the active system node, and halting a redundant system of the nodes.

However, because a RAID device itself has become to execute mirroring between disks accompanying the enhancement of functions provided by RAID devices, a problem arises that data writing is not appropriately executed.

The reason for this is as follows: when the RAID device itself performs mirroring between disks, there are a copy source disk and a copy destination disk; and the volume manager has to write data only onto the copy source disk to keep synchronization, however, the RAID device cannot distinguish the copy source disk from the other disks, because the volume manager does not manage mirroring of the RAID device.

Furthermore, if an error occurs in a copy source disk in a RAID device, the problem is even more serious, because the RAID device itself is to alter its copy source disk to a copy destination disk, and to alter an initial copy destination disk to a copy source disk in some cases.

### SUMMARY OF THE INVENTION

It is an object of the present invention to at least partially solve the problems in the conventional technology.

According to an aspect of the present invention, a computer-readable recording medium stores therein a computer program for managing a device of a redundant array of independent disks (RAID device) configured to perform mirroring among a plurality of disks. The computer program causes the computer to execute determining a copy source disk from among the independent disks; storing identification information about the copy source disk into a storage unit; and writing data onto the copy source disk corresponding to the identification information stored in the storage unit.

According to another aspect of the present invention, a method of managing a device of a redundant array of independent disks (RAID device) configured to perform mirroring among a plurality of disks includes determining a copy source disk from among the independent disks; storing identification information about the copy source disk into a storage unit; and writing data onto the copy source disk corresponding to the identification information stored in the storage unit.

According to still another aspect of the present invention, a RAID management apparatus that manages a device of a redundant array of independent disks (RAID device) configured to perform mirroring among a plurality of disks includes a determining unit that determines a copy source disk from among the independent disks; a storing unit that stores identification information about the copy source disk into a storage unit; and a writing unit that writes data onto the copy source disk corresponding to the identification information stored in the storage unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram of a system configuration of a RAID management system according to an embodiment of the present invention;

FIG. 2 is a functional block diagram of a RAID management apparatus shown in FIG. 1;

FIG. 3 is a schematic diagram of an example of disk management table according to the embodiment;

FIG. 4 is a flowchart of a process procedure performed by a disk determination unit shown in FIG. 2;

FIG. 5 is a flowchart of a process procedure of writing data onto disks performed by the RAID management apparatus shown in FIG. 2; and

FIG. 6 is a schematic diagram of a computer that executes a RAID management program.

### DETAILED DESCRIPTION OF THE PREFERRED EMBODIMENTS

Exemplary embodiments of the present invention will be explained below in detail with reference to accompanying drawings.

First of all, a concept of management of redundant array of independent disks (RAID) according to an embodiment of the present invention is explained below. A RAID management apparatus according to the embodiment accesses a plurality of RAID devices, determines a RAID device that includes a writable disk of a copy source (hereinafter, a copy source disk), and executes writing onto the copy source disk of the determined RAID device. In this case, the copy source disk is a disk to be a copy source when the RAID devices perform mirroring.

When the RAID management apparatus determines that a trouble occurs in the RAID device, the copy source disk is altered to a copy destination disk, and a disk in another RAID device is altered from the disk of a copy destination (hereinafter, a copy destination disk) to a copy source disk; the RAID management apparatus in operation notifies a standby RAID management apparatus of information about the RAID device that includes the disk to be a new copy source. In this case, the copy destination disk. is a disk to be a copy destination when the RAID devices perform mirroring.

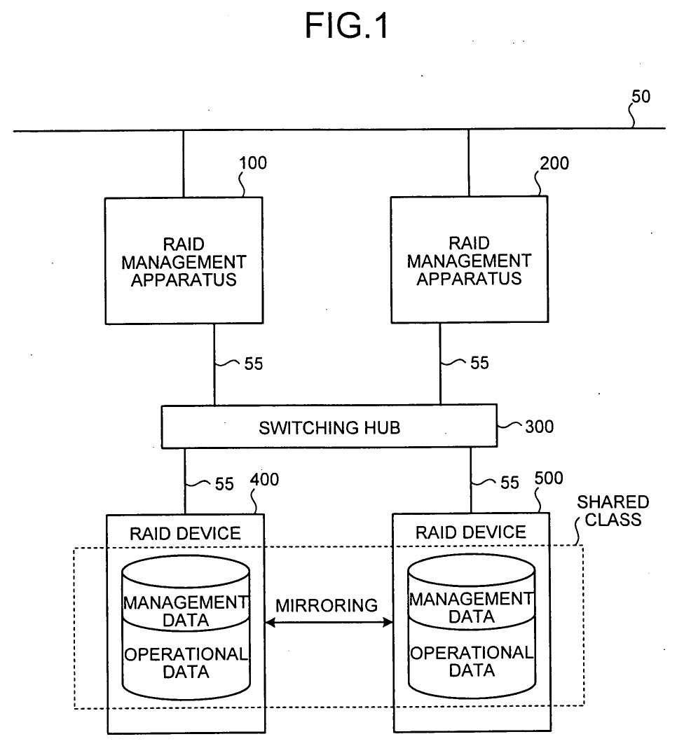

System configuration of a RAID management system according to the embodiment is explained below. As shown in FIG. 1, in the RAID management system, RAID management apparatuses 100 and 200 are connected to each other with a local area network (LAN) 50. The RAID management apparatuses 100 and 200, and RAID devices 400 and 500 are connected to a switching hub 300 with a small computer system interface (SCSI) (or a fiber channel cable). For the convenience of explanation, two RAID management apparatuses and two RAID devices are shown in FIG. 1; however, the present invention is not limited to this.

The RAID management apparatus 100 is an apparatus that receives data from a host computer, which is not shown, and writes the received data onto a copy source disk. Specifically, the RAID management apparatus 100 accesses each of the RAID devices, determines a RAID device that includes the copy source disk, and writes data onto the disk in the determined RAID device. The RAID management apparatus 200 is similar to the RAID management apparatus 100.

If an error occurs in the RAID device, the RAID device that has the copy source disk is switched over to another RAID device, the RAID management apparatus 100 notifies a standby RAID management apparatus of information about switched RAID device.

For example, suppose a RAID management apparatus in operation is the RAID management apparatus 100, a standby RAID management apparatus is the RAID management apparatus 200, a RAID device that includes a copy source disk is the RAID device 400, and a RAID device that includes a copy destination disk is the RAID device 500. When an error occurs in the RAID device 400, the disk in the RAID device 400 is switched over form the copy source to the copy destination, and the disk in the RAID device 500 is switched over from the copy destination to the copy source; the RAID management apparatus 100 notifies the RAID management apparatus 200 that the RAID device that includes the copy source disk is the RAID device 500.

The switching hub 300 learns physical addresses of Ethernet (registered trademark) devices (such as an Ethernet (registered trademark) card) connected to ports of the RAID management apparatuses 100 and 200, and the RAID devices 400 and 500, and provides data exchanges between the devices by directly connecting ports required for communication.

The RAID device 400 includes a disk to be recorded with data, and performs mirroring with the RAID device 500. When the disk included in the RAID device 400 is the copy source disk and the disk included in the RAID device 500 is the copy destination disk, data recorded on the disk in the RAID device 400 is copied onto the disk in the RAID device 500; on the contrary, when the disk in the RAID device 400 is the copy destination disk and the disk in the RAID device 500 is the copy source disk, data recorded on the disk in the RAID device 500 is copied onto the disk in the RAID device 400.

If an error occurs in the RAID device 400 in a state where the RAID device 400 includes the copy source disk and the RAID device 500 includes the copy destination disk, the RAID device 400 notifies the RAID device 500 that the error occurs in the RAID device 400. The RAID device 400 then switches the copy source disk to a copy destination disk, and the RAID device 500 switches the copy destination disk to a copy source disk.

By contrast, if an error occurs in the RAID device 500 in a state where the RAID device 500 includes the copy source disk and the RAID device 400 includes the copy destination disk, the RAID device 500 notifies the RAID device 400 that the error occurs in the RAID device 500. The RAID device 500 then switches the copy source disk into a copy destination disk, and the RAID device 400 switches the copy destination disk into a copy source disk.

The respective disks included in the RAID devices 400 and 500 store therein management data and operational data. The management data is data for managing disks, and the operational data is data written by the RAID management apparatus 100 or 200.

The RAID management apparatus 100 shown in FIG. 1 is explained below. The RAID management apparatus 100 includes a control unit 110, an interface unit 120, a disk determination unit 130, a storage unit 140, an input-output (I/O) processing unit 150, and a disk notification unit 160.

The control unit 110 controls the RAID management apparatus 100 as a whole, and the interface unit 120. performs communication with a host computer (not shown) or other devices in accordance with a certain communication protocol.

The disk determination unit 130 accesses the RAID devices 400 and 500, determines which RAID device includes the copy source disk, and stores a determination result into the storage unit 140.

Moreover, the disk determination unit 130 determines whether a volume is made from a disk that is mirrored by a function of the RAID device and forms the RAID device, and notifies the I/O processing unit 150 of a determination result.

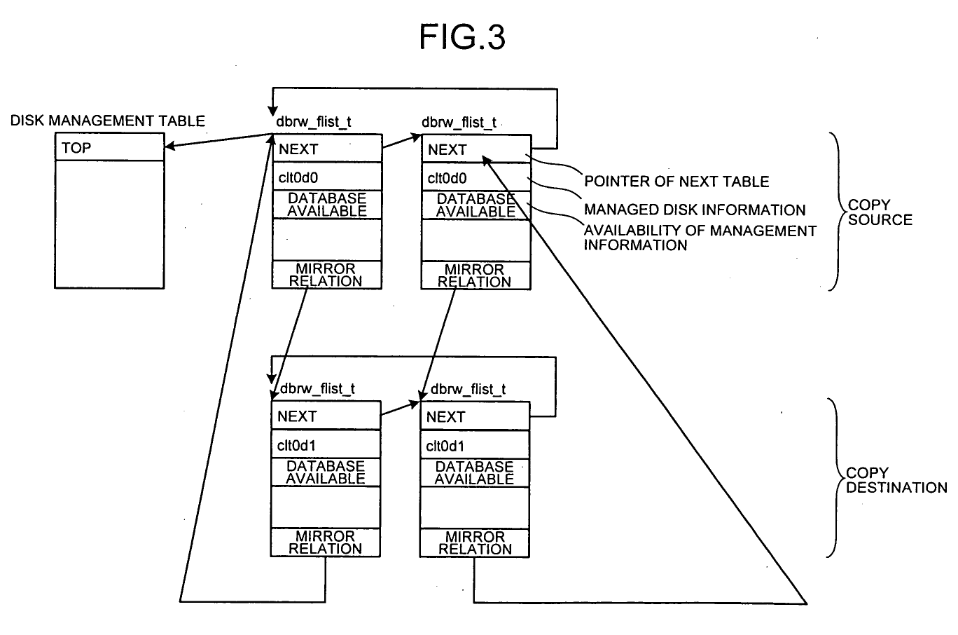

The storage unit 140 stores therein information about a disk management table for identifying a copy source disk. FIG. 3 is a schematic diagram of an example of the disk management table. As shown in the figure, an address (pointer) corresponding to the copy source disk is stored at the top of the disk management table.

Moreover, into the disk management table, the disk determination unit 130 records pointer information about the table related to the copy source disk and the copy destination disk, managed disk information for specifying a disk subjected to management, information whether the disk includes management information, and information about a reciprocal relationship between disks in the mirror relation.

If the relation between the copy source disk and the copy destination disk is switched, the I/O processing unit 150 rewrites the pointer at the top of the disk management table based on information about the reciprocal relationship in the mirror relation, so that a disk of the new copy source can be accessed.

The I/O processing unit 150 writes data received from the host computer onto the copy destination disk based on the disk management table. Moreover, if the copy source disk and the copy destination disk are switched over to each other, the I/O processing unit 150 rewrites the pointer at the top of the disk management table to the pointer of a disk of the new copy source, and notifies the disk notification unit 160 that the copy source disk and the copy destination disk are switched over to each other.

If the I/O processing unit 150 executes writing onto the copy source disk, which results in a writing error, the I/O processing unit 150 determines that the copy source disk and the copy destination disk are switched.

When the disk notification unit 160 receives information about the switch of the copy source disk from the I/O processing unit 150, the disk notification unit 160 notifies the RAID management apparatus 200 on standby of information about the pointer stored at the top of the disk management table. In such case, the disk management table stored in the RAID management apparatus 200 is to be renewed.

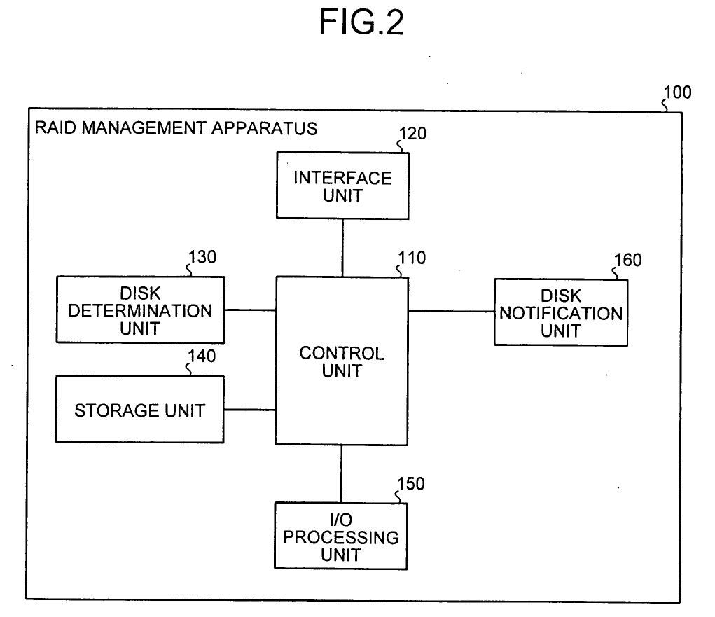

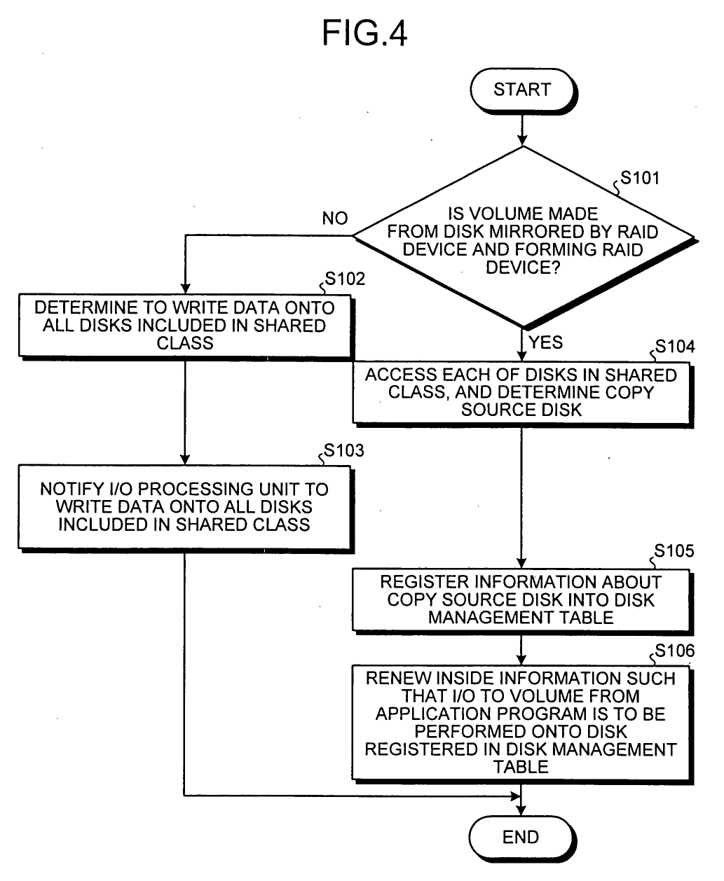

Processing performed by the disk determination unit 130 of the RAID management apparatus 100 shown in FIG. 2 is explained below with reference to a flowchart of the processing shown in FIG. 4.

As shown in FIG. 4, the disk determination unit 130 determines whether a volume is made from a disk that is mirrored by a function of the RAID device and forms the RAID device (step S101).

If the volume is not mirrored by the RAID device (No at step S101), the disk determination unit 130 determines that data is to be written onto all disks included in a shared class (step S102), and notifies the I/O processing unit 150 to write the data onto the all disks included in the shared class (step S103).

By contrast, if the volume is made from the disk mirrored by the RAID device and forming the RAID device (Yes at step S101), the disk determination unit 130 accesses each of the disks in the shared class, and determines a copy source disk (step S104).

The disk determination unit 130 then registers information about the copy source disk into the disk management table (step S105), and renews inside information such that I/O to the volume from an application program is to be performed onto the disk registered in the disk management table (step S106).

Thus, the disk determination unit 130 registers information about the copy source disk into the disk management table in the storage unit 140, so that the I/O processing unit 150 can write data onto an appropriate disk.

Processing of writing data onto disks by the RAID management apparatus 100 shown in FIG. 2 is explained below.

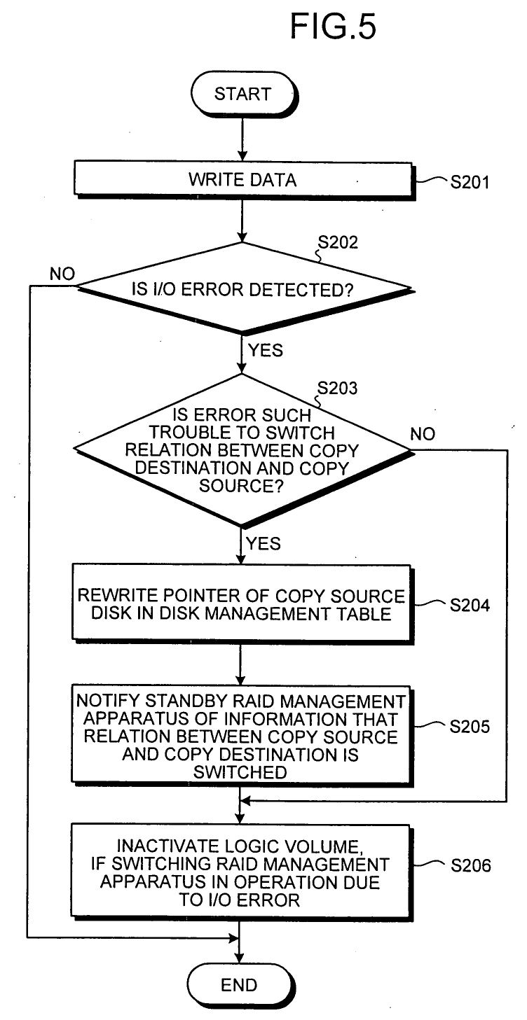

As shown in a flowchart of the processing in FIG. 5, in the RAID management apparatus 100, the I/O processing unit 150 writes data (step S201), determines whether an I/O error is detected (step S202). If no I/O error is detected (No at step S202), the processing is terminated.

By contrast, if an I/O error is detected (Yes at step S202), the I/O processing unit 150 determines whether the error is such trouble to switch the relation between the copy source and the copy destination (step S203). If it is the trouble such that the relation between the copy source and the copy destination needs to be switched (Yes at step S203), the I/O processing unit 150 rewrites the pointer of the copy source disk in the disk management table (step S204), and then the disk notification unit 160 notifies the RAID management apparatus 200 of information that the relation between the copy source and the copy destination is switched (step S205).

In addition, if the RAID management apparatus in operation is to be switched due to the I/O error, a logic volume is then inactivated (step S206). By contrast, if the error is not such trouble that the relation between the copy source and the copy destination is switched (No at step S203), the process control directly goes to step S206.

In this way, if an I/O error is detected, and the relation between the copy source disk and the copy destination disk is switched, the I/O processing unit 150 rewrites the pointer of the copy source disk set in the disk management table, and the disk notification unit 160 notifies the RAID management apparatus 200 on standby that the disks are switched, so that data can be appropriately written on the copy source disk.

Thus, in the RAID management apparatus 100, the disk determination unit 130 accesses each of the disks, determines a copy source disk, and sets a pointer of the determined copy source disk in the disk management table in the storage unit 140; and the I/O processing unit 150 writes data onto the copy source disk based on the disk management table.

In addition, if the I/O processing unit 150 accesses a disk, and an I/O error occurs on the disk, and the copy source disk and the copy destination disk are switched, the I/O processing unit 150 renews a pointer related to the copy source disk in the disk management table; and the disk notification unit 160 notifies the RAID management apparatus 200 on standby that the disks are switched, so that data can be appropriately written on the copy source disk even in the RAID device that independently performs mirroring.

Each of the processes explained above can be implemented by executing a computer program on a computer. In the following, an example of a computer that executes a RAID management program that has similar functions to the above embodiment is explained.

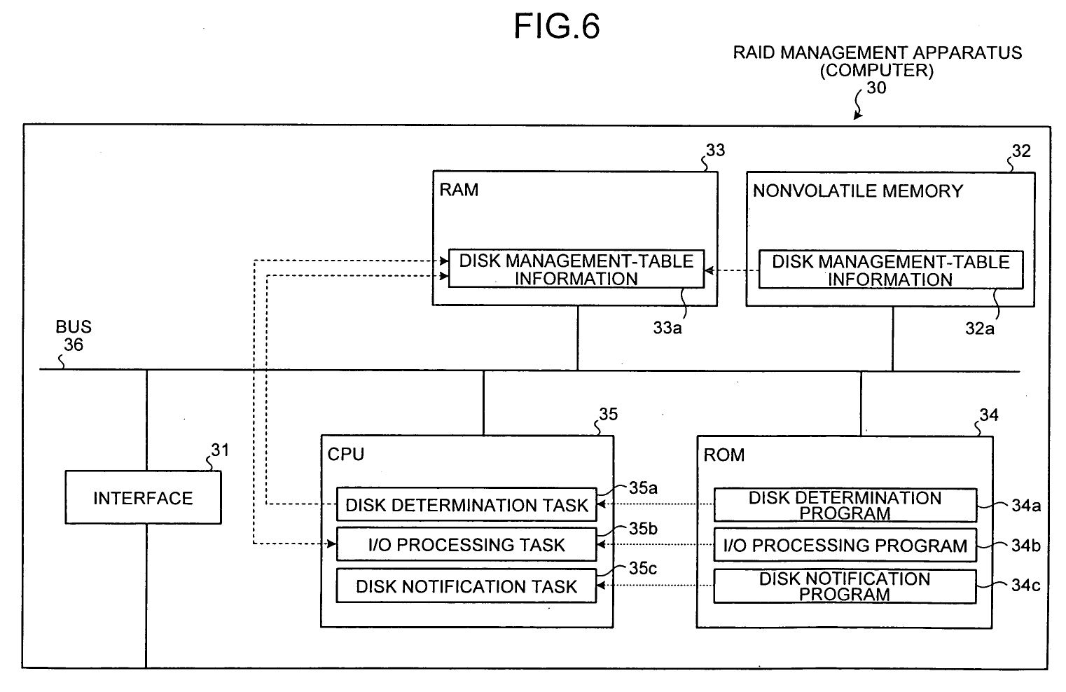

As shown in a schematic diagram of the computer in FIG. 6, a computer 30 as a RAID management apparatus includes an interface 31, a nonvolatile memory 32, a random access memory (RAM) 33, a read-only memory (ROM) 34, and a central processing unit (CPU) 35, all of which are connected with a bus 36. In FIG. 6, the interface 31 corresponds to the interface unit 120 shown in FIG. 2.

The ROM 34 pre-stores therein RAID management programs, namely, a disk determination program 34a, an I/O processing program 34b, and a disk notification program 34c, as shown in FIG. 6, which serve similar functions to those described in the above embodiment.

The CPU 35 reads out the programs 34a to 34c from the ROM 34 and executes them, as a result, the programs 34a to 34c function as a disk determination task 35a, an I/O processing task 35b, and a disk notification task 35c, respectively. The tasks 35a to 35c correspond to the disk determination unit 130, the I/O processing unit 150, and the disk notification unit 160 shown in FIG. 2, respectively.

The nonvolatile memory 32 is provided with disk management-table information 32a as shown in FIG. 6. The disk management-table information 32a corresponds to the disk management table stored in the storage unit 140 shown in FIG. 2. The CPU 35 registers the disk management-table information into the RAM 33, and records information, for example, information about the pointer of a copy source disk, into the disk management-table information.

The programs 34a to 34c do not need to be initially stored in the ROM 34. Each of the programs can be stored in, for example, a portable physical medium configured to be inserted into a computer, such as a flexible disk (FD), a compact disk read only memory (CD-ROM), a digital versatile disk (DVD), a magneto-optical disk (MO), and an integrated circuit (IC) card. The programs can be stored in a fixed physical medium, such as a hard disk drive (HDD) provided in or out of the computer 30. Alternatively, the programs can be stored in another computer (or a server) that is connected to the computer 30 via a public line, the Internet, a local area network (LAN), or a wide area network (WAN). The computer 30 can read out each of the programs from one of these, and execute the program.

According to an aspect of the present invention, data can be written onto a copy source disk included even in a RAID device that independently performs mirroring.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A computer-readable recording medium that stores therein a computer program for managing a device of a redundant array of independent disks (RAID device) configured to perform mirroring among a plurality of disks, the computer program causing the computer to execute:
determining a copy source disk from among the independent disks;
storing identification information about the copy source disk into a storage unit; and
writing data onto the copy source disk corresponding to the identification information stored in the storage unit.

2. The computer-readable recording medium according to claim 1, wherein, if the copy source disk is switched from a first disk to a second disk, the computer program further causing the computer to execute renewing the identification information stored in the storage unit from identification information about the first disk to identification information about the second disk.

3. The computer-readable recording medium according to claim 1, wherein, if the copy source disk is switched from a first disk to a second disk, the computer program further causing the computer to execute notifying information about the second disk to an apparatus that manages the RAID device.

4. A method of managing a device of a redundant array of independent disks (RAID device) configured to perform mirroring among a plurality of disks, the method comprising:
determining a copy source disk from among the independent disks;
storing identification information about the copy source disk into a storage unit; and
writing data onto the copy source disk corresponding to the identification information stored in the storage unit.

5. The method according to claim 4, wherein, if the copy source disk is switched from a first disk to a second disk, the computer program further causing the computer to execute renewing the identification information stored in the storage unit from identification information about the first disk to identification information about the second disk.

6. The method according to claim 4, wherein, if the copy source disk is switched from a first disk to a second disk, the computer program further causing the computer to execute notifying information about the second disk to an apparatus that manages the RAID device.

7. A RAID management apparatus that manages a device of a redundant array of independent disks (RAID device) configured to perform mirroring among a plurality of disks, the method comprising:
a determining unit that determines a copy source disk from among the independent disks;
a storing unit that stores identification information about the copy source disk into a storage unit; and
a writing unit that writes data onto the copy source disk corresponding to the identification information stored in the storage unit.

8. The RAID management apparatus according to claim 7, wherein, if the copy source disk is switched from a first disk to a second disk, the computer program further causing the computer to execute renewing the identification information stored in the storage unit from identification information about the first disk to identification information about the second disk.

9. The RAID management apparatus according to claim 7, wherein, if the copy source disk is switched from a first disk to a second disk, the computer program further causing the computer to execute notifying information about the second disk to another apparatus that manages the RAID device.
